(19) United States
(12) Patent Application Publication
(10) Pub. No.: US 2009/0230675 A1
(43) Pub. Date: Sep. 17, 2009

(54) Cuff seal using single clamp

(75) Inventor: Scott Foster Densmore, Davison, MI (US)

Correspondence Address: HARNESS, DICKEY & PIERCE, P.L.C., P.O. BOX 828, BLOOMFIELD HILLS, MI, 48303, US

(73) Assignee: DENSO International America, Inc., Southfield, MI (US)

(21) Appl. No.: 12/077,181

(22) Filed: Mar. 17, 2008

(51) Int. Cl. F16L 21/00

(52) U.S. Cl. 285/236

(57) ABSTRACT

A cuff seal may include an annular body having an outer radial portion, an inner radial portion, and an end portion; an annular groove disposed between the outer radial portion and the inner radial portion; and a clamp disposed around the outer radial portion, the clamp being adapted to constrict the annular body. The outer radial portion, the inner radial portion, and the end portion form a U-shaped cross-section defining the annular groove, and the annular groove includes an open end and a closed end.

### FIELD

The present disclosure relates to a sealed connection between two tubular members and more particularly to a cuff seal connecting an air duct to a throttle body.

### BACKGROUND

The statements in this section merely provide background information related to the present disclosure and may not constitute prior art. Conventional internal combustion engines may include a throttle body for controlling airflow into an intake manifold. An air duct may be connected to the throttle body through which filtered air from the air filter may be delivered. Accordingly, it may be necessary to provide a sealed connection between the air duct and the throttle body to prevent unfiltered, and potentially dirty, air from being drawn through the throttle body at such a connection.

Rubber cuffs may be employed to couple the air duct and the throttle body. Such connectors may include more than one metal strap to hold the connector to the duct and the throttle body. Traditionally, such cuffs rely on tightening the metal straps very tightly to secure the cuff, throttle body and duct. However, because the parts must be assembled onto a new vehicle at final vehicle assembly, considerable time must be used to assemble and tighten the cuff, throttle body and duct at final vehicle assembly. It is desirable that such cuffs possess physical part characteristics to permit the air duct and cuff to remain together during part shipment, and also for a metal strap to remain loosely attached yet available facilitate final assembly onto a throttle body before the strap is tightened during final assembly.

Additionally, when assembled in a vehicle, because the throttle body is typically in close proximity to a heat-generating engine block, the throttle body, duct and connector may expand and contract in response to the wide range of temperatures associated with such proximity. Additionally, the connection may be subjected to a wide range of vibration. This may cause leaks in the connection.

What is needed then is a cuff and air duct that are capable of being connected together in an airtight seal yet capable of remaining together during shipment and final assembly to a throttle body.

### SUMMARY

In one form, the present disclosure may provide a cuff seal which may include an annular body having an outer radial portion, an inner radial portion, and an end portion. An annular groove may be disposed between the outer radial portion and the inner radial portion. A clamp may be disposed around the outer radial portion, such that the clamp may constrict or compress the annular body. The outer radial portion, the inner radial portion, and the end portion may form a U-shaped cross-section defining the annular groove, which may include an open end and a closed end.

In another form, the present disclosure may provide a system for connecting and sealing tubular members. The system may include a first tubular member including an inner diameter, an outer diameter, and numerous slots disposed through the inner diameter and the outer diameter. The slots and the adjacent material may form flexible fingers to accommodate insertion, including biased insertion, into a cuff. A second tubular member may include an inner diameter and an outer diameter with the outer diameter having a protuberance, such as a barbed protuberance. An annular cuff may include an outer portion and an inner portion with an annular groove therebetween to thereby form a U-shaped cross-section. The annular cuff may be adapted to interconnect or join the first tubular member and the second tubular member and thereby form an airtight seal. The flexible fingers of the first tubular member may be received within the annular groove but with restrain, resistance or biasing of the fingers during insertion. An outer diameter of the second tubular member may be pressed into engagement with the inner portion of the annular cuff, whereby the inner portion is disposed between the first tubular member and the second tubular member.

In yet another form, the present disclosure may provide a system that may include an air duct having numerous slots disposed therethrough to form a number of flexible fingers. A throttle body may have a tubular portion and a flange portion with the tubular portion having a rim. An annular cuff may couple the air duct and the throttle body. The annular cuff may have a U-shaped cross-section formed by an end face, an inner portion, an outer portion, with an annular groove disposed therebetween. The inner portion may have a plurality of teeth or ribs and a first recess or groove. A clamp may be disposed around the outer portion, the clamp being adapted to selectively constrict the annular cuff. The flexible fingers of the duct may be received into the annular groove. A lip or protuberance may be disposed on the fingers to snap-fit into or resiliently spring back and fit into a second recess or groove disposed at a closed end of the annular groove. The tubular portion of the throttle body may be received into the inner portion of the annular cuff, the teeth or ribs of the inner portion of the annular cuff permitting insertion of the tubular portion and resisting disengagement between the tubular portion and the inner portion. Disengagement is resisted because the numerous teeth or ribs are more easily deflected in a tubular insertion direction than in a tubular disengagement direction.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a partial perspective view of an air duct, cuff seal and throttle body according to the present disclosure;

FIG. 2 is a partial perspective view of the cuff seal of FIG. 1, with the air duct and throttle body depicted in phantom lines;

FIG. 3 is an exploded perspective view of the air duct, cuff seal and throttle body of FIG. 1;

FIG. 4 is a cross-sectional view of the cuff seal engaging the throttle body and the air duct;

FIG. 5 is a partially exploded cross-sectional view of the cuff seal and the air duct according to the present disclosure;

FIG. 6 is a partial cross-sectional view of the air duct being inserted into the cuff seal according to the present disclosure;

FIG. 7 is a partial cross-sectional view of the air duct and the cuff seal;

FIG. 8 is a partially exploded cross-sectional view of the throttle body, the cuff seal, and the air duct fully engaged according to the present disclosure;

FIG. 9 is a partial cross-sectional view of the throttle body being inserted into the cuff seal with the air duct fully engaged according to the present disclosure; and

FIG. 10 is a partial cross-sectional view of cuff seal fully engaged with the throttle body and the air duct.

### DETAILED DESCRIPTION

The following description is merely exemplary in nature and is not intended to limit the present disclosure, application, or uses. It should be understood that throughout the drawings, corresponding reference numerals indicate like or corresponding parts and features.

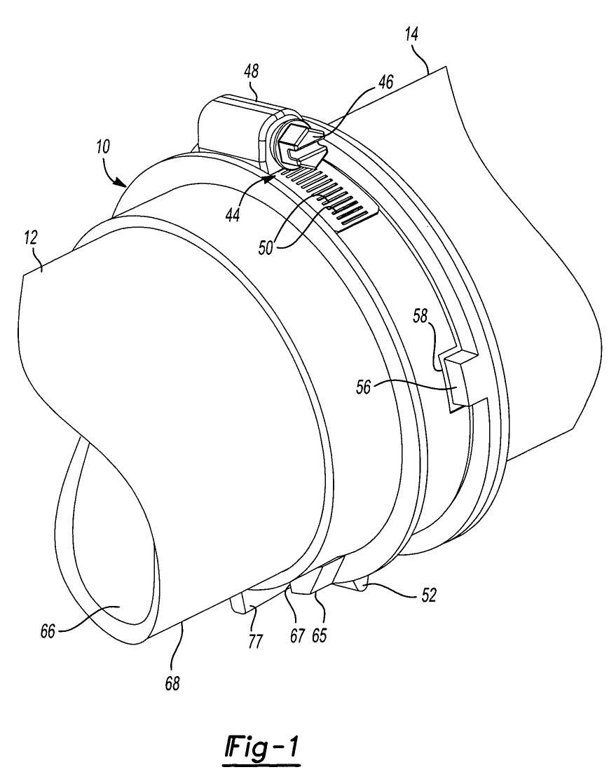

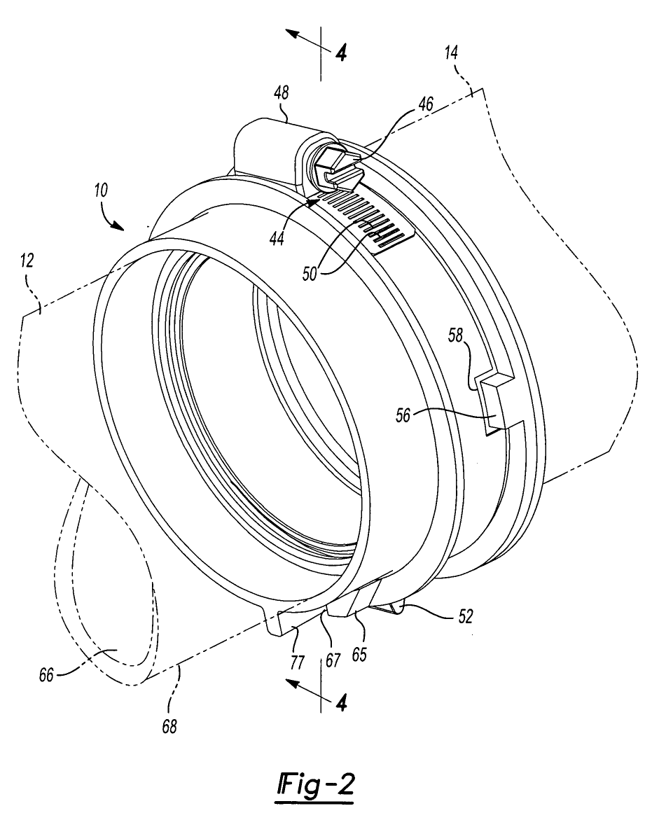

With reference to FIGS. 1-10, and initially FIGS. 1-4, a cuff seal 10 is provided which may interconnect an air duct 12 and a throttle body 14 and provide a sealed relationship for fluid flow therebetween. The air duct 12 may route air from an air filter (not shown), for example, to the throttle body 14. The throttle body 14 may control an air flow to an internal combustion engine (not shown) for a vehicle, for example.

The cuff seal 10 may be a resiliently flexible and generally cylindrical annular body formed from Ethylene-Propylene-Diene-Monomer (EPDM) rubber, for example, or any other suitable resiliently flexible rubber-like material. Such a material, which may be injection molded or otherwise suitably formed, must be capable of enduring temperatures and vibrations commonly experienced in an engine compartment of a vehicle. The cuff seal 10 may include a radial inner portion 16, a radial outer portion 18, and an end portion 20. The inner portion 16, the outer portion 18, and the end portion 20 may form a substantially U-shaped cross section defining an annular groove 22.

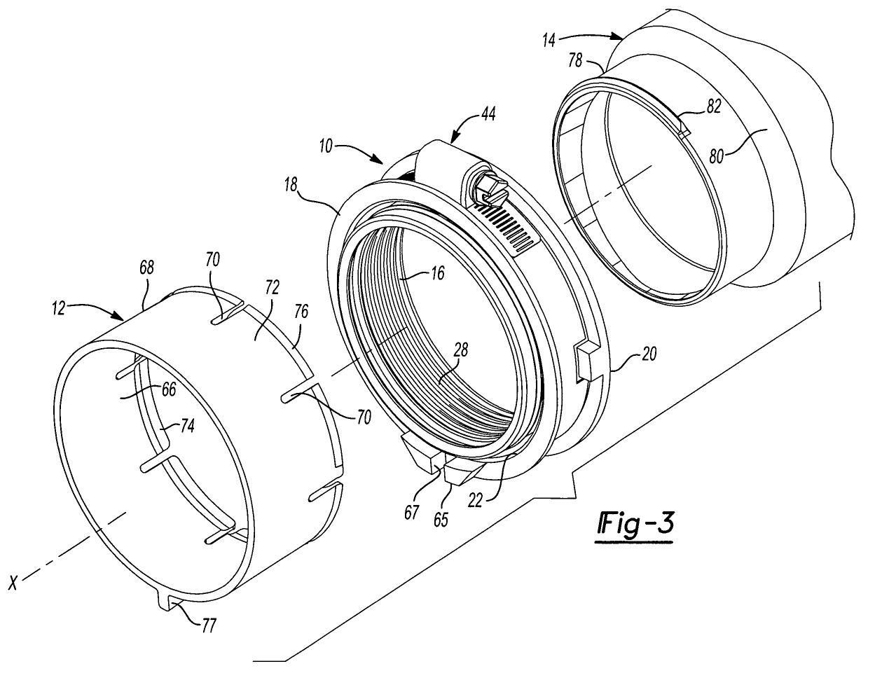

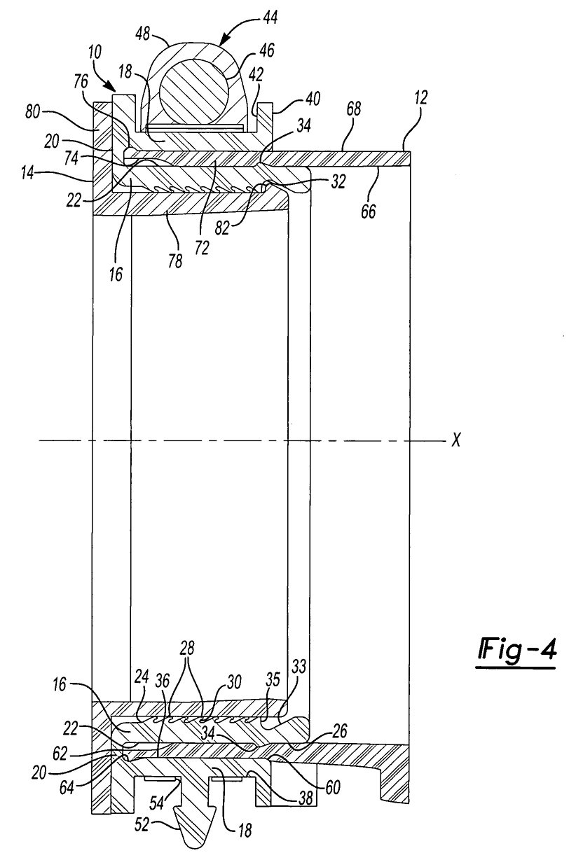

With reference including FIG. 4, the inner portion 16 may be a generally cylindrical ring including an inner diameter 24 and an outer diameter 26, while the inner portion 16 may be resiliently flexible relative to the outer portion 18 and the end portion 20. The inner portion 16 may also include a plurality of ribs or teeth 28 disposed on the inner diameter 24, extending 360 degrees thereon. The teeth 28 may be angled generally inward and away from the end portion 20 (see, e.g., FIG. 4). The ribs 28 may deflect in response to a shear force applied thereto, for instance, as the throttle body 14 is inserted into the inner portion 16 from left to right (relative to the view shown in FIG. 4). The ribs 28 may be relatively stiff or resist flexure in the opposite direction, i.e., right to left relative to the view shown in FIG. 4. Each of the ribs 28 may also include an undercut 30 to further facilitate deflection of the ribs 28 away from longitudinal axis X during insertion of the throttle body 14 in the manner described above. Otherwise, the ribs 28 protrude toward the longitudinal axis X.

The inner portion 16 may also include an annular recess 32 and a protuberance 34. The annular recess 32 may be disposed in the inner diameter 24 and may include a generally oblong or teardrop shaped cross-section having a sloped portion 33 and a step portion 35. The oblong or teardrop shape may enable the annular recess 32 to receive a portion of the throttle body 14, facilitating a snap-fit engagement therebetween, while hindering disengagement therebetween, as will be subsequently described.

The protuberance 34 may be disposed on the outer diameter 26 and may extend 360 degrees thereon. The protuberance 34 may be angled generally outward from the inner portion 16, toward the end portion 20, although one skilled in the art will appreciate that the protuberance 34 could be otherwise suitably shaped, for instance, approximately perpendicular or perpendicularly away from axis X. The protuberance 34 may be a sealing member which may be resiliently compressed against the air duct 12 to supplement the sealed relationship between the cuff seal 10 and the air duct 12. It should be appreciated that the protuberance 34 may extend into the annular groove 22 from the outer portion 18. The protuberance 34 also aids in retaining the cuff seal 10 to the air duct 12 during shipping, that is, the protuberance assists in joining the cuff seal 10 and the air duct 12.

The outer portion 18 may include an inner diameter 36 and an outer diameter 38. A wall 40 may be disposed on or molded into the outer diameter 38, extending radially outward therefrom, 360 degrees around the axis of rotational symmetry, axis X. The wall 40 may cooperate with the end portion 20 to form a channel 42 extending around the outer periphery of the cuff seal 10.

A clamp 44 may be disposed around the outer portion 18, within the channel 42. The clamp 44 may be a flexible strap formed from stainless steel, or any other suitably durable metal or polymer with sufficient tensile strength to constrictingly restrain the cuff seal 10, the air duct 12, and the throttle body 14. The clamp 44 may include a screw 46 engaging a saddle 48 fixed to one end of the strap. The screw 46 may be turned relative to the saddle 48 to incrementally engage or disengage slots 50 disposed on the strap to tighten or loosen the constricting force that the clamp 44 applies to the cuff seal 10. A suitable clamp used to tighten the cuff seal 10 around the air duct 12 and the throttle body 14 may also be one that is conducive to a vehicle engine compartment. Generally, as the clamp 44 is tightened, a force directed radially toward the axis X increases about the entire perimeter of the clamp 44. As the clamp 44 is tightened, the resilient material of the cuff seal may compress and store potential energy (i.e. a restoring force) against the clamp 44.

The outer portion 18 may also include a resiliently flexible barbed protuberance 52 extending radially outward through an aperture 54 in the clamp 44. The barbed protuberance 52 prevents relative rotation between the clamp 44 and the cuff seal 10. Additionally or alternatively, the outer portion may include a key feature 56 disposed through a keyway 58 in the clamp 44 to prevent relative rotation between the clamp 44 and the cuff seal 10.

As described above, the annular groove 22 may be defined by the U-shaped cross-section formed from the inner portion 16, the outer portion 18 and the end portion 20. FIG. 4 depicts that the annular groove 22 may include an open end 60, a closed end 62 (defined by the end portion 20), and an annular recess 64 disposed at or near the closed end 62. The annular recess 64 may extend into the outer portion 18 as shown in FIG. 4, or alternatively, into the inner portion 16. Regardless, the annular recess 64 provides a secure locking feature, that is enhanced with compression or force, within the annular groove 22. The annular recess 64 may receive a portion of the air duct 12 for a snap-fit or a detent engagement therebetween, as will be subsequently described. The annular recess 64 may have a substantially semicircular cross-sectional shape, although the annular recess 64 may alternatively include the teardrop shape described above with reference to the annular recess 32.

The cuff seal 10 may also include a boss 65 disposed outboard of the annular groove 22 (shown best in FIG. 3). The boss 65 may include a keyway 67 adapted to engage a portion of the air duct 12, as will be subsequently described.

The air duct 12 may be generally tubular, and may be formed from Nylon 6, for example, or any other suitable polymeric material. The air duct 12 may include an inner diameter 66, an outer diameter 68, and a plurality of slots 70 disposed through the inner and outer diameters 66, 68, thereby forming a plurality of resiliently flexible fingers 72. The fingers 72 may include an undercut 74 to facilitate resilient deflection of the fingers 72 and to facilitate ease of insertion of the fingers 72 over the protuberance 34.

The air duct 12 may also include a lip 76 disposed around an edge of the outer diameter 68. The lip 76 may restrainingly engage the annular recess 64 in the annular groove 22, as will be subsequently described. A key 77 may be disposed on the outer diameter 68 of the air duct 12 and may slidably engage the keyway 67 of the cuff seal 10 to prevent relative rotation between the air duct 12 and the cuff seal 10.

With continued reference to FIGS. 3 and 4, the throttle body 14 may be formed from aluminum, for example, or material suitable to the environment of a vehicle engine compartment. The throttle body 14 may include a tubular portion 78 and a body portion 80. A retaining barb 82 may be disposed on the outer diameter of the tubular portion 78 and may extend up to 360 degrees around the circumference of the tubular portion 78. To take full advantage of the securing contact and retaining quality of the retaining barb 82 against the teeth or ribs 28, the retaining barb 82 may extend 360 degrees around the tubular portion 78 to provide the greatest amount of securing contact. Upon insertion, the retaining barb 82 may restrainingly engage the annular recess 32 disposed in the inner portion 16 of the cuff seal 10. Stated differently, the retaining barb 82, upon full insertion of the tubular portion 78, may drop into or lodge into the annular recess 32 of the cuff seal 10. Upon and during insertion, the retaining barb 82 compresses against the teeth or ribs 28 to momentarily compress or collapse the ribs 28. As previously stated, because the ribs 28 are angled in the direction of tubular portion 78 insertion, and equipped with an undercut 30, the ribs collapse much more easily than when withdrawal of the tubular portion is attempted. The cuff seal 10 and the air duct 12 may be assembled together before shipment to a vehicle final assembly facility, where the throttle body may 12 then be assembled into the cuff seal 10 and the clamp 44 subsequently tightened. The clamp 44 is fully tightened after the air duct 12 and cuff seal 10 are assembled onto the throttle body 14. An advantage of the present disclosure is that the clamp 44 need only be tightened about the cuff seal 10 and air duct 12 upon assembly of the air duct 12 and the cuff seal 10 onto the throttle body 14.

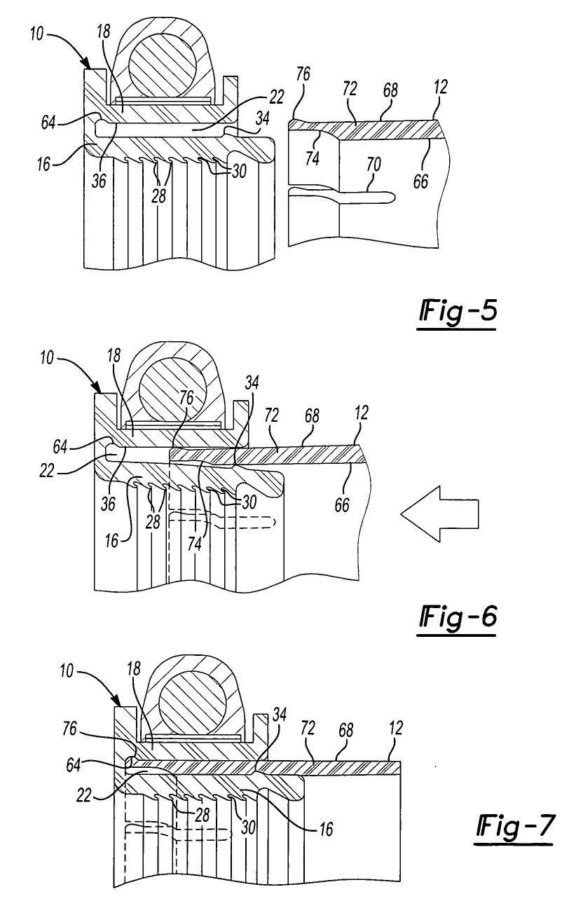

With continued reference to FIGS. 1-10, operation of the cuff seal 10 will be described in greater detail. As described above, the cuff seal 10 may receive and engage the air duct 12 and the throttle body 14, forming a sealed connection therebetween. FIGS. 5-7 depict the air duct 12 being inserted into the annular groove 22 of the cuff seal 10. As the fingers 72 are pressed into the annular groove 22, the lip 76 will contact the inner diameter 36 of the outer portion 18 and the protuberance 34 will contact the inner diameter 66 of the air duct 12, thereby causing the fingers 72 and the inner portion 16 of the cuff seal 10 to resiliently flex inward, toward the inner area or portion of the cuff 10, biasing the fingers 72 against the outer portion 18 (FIG. 6). The arrow of FIG. 6 depicts the insertion direction of the air duct 12. Additionally, when the throttle body 14 is inserted into the cuff seal 10, the fingers 72 may flex outward, away from the centerline of the cuff seal 10, thus creating a tight seal or fit between the throttle body 14, cuff seal 10 and air duct 12.

As depicted in FIG. 7, in a fully engaged position of the air duct 12, the lip 76 may snap into or lodge into the detent or annular recess 64 such that the snap or lodging may be felt by a person doing the assembly. The stiffness of the fingers 72 and the inner portion 16 may biasingly restrain the lip 76 within the annular recess 64, thereby restrainingly engaging the air duct 12 within the cuff seal 10. That is, force will be necessary to install the air duct 12 into the cuff seal 10 and withdraw the air duct 12 from the cuff seal 10. In this manner, the geometry of the air duct 12 and the annular groove 22 allow the air duct 12 to be pressed, with hand force, into engagement with the cuff seal 10, while hindering disengagement therebetween. For instance, a greater force may be necessary to disengage the air duct 12 and the cuff seal 10. The biasing relationship between the cuff seal 10 and the air duct 12 also facilitates the sealed relationship therebetween. That is, there is contact between the air duct 12 and the cuff seal 10 during insertion. Additionally, as described above, the protuberance 34 may be biasingly compressed against the fingers 72 forming a seal therebetween and supplementing the retaining engagement between the cuff seal 10 and the air duct 12.

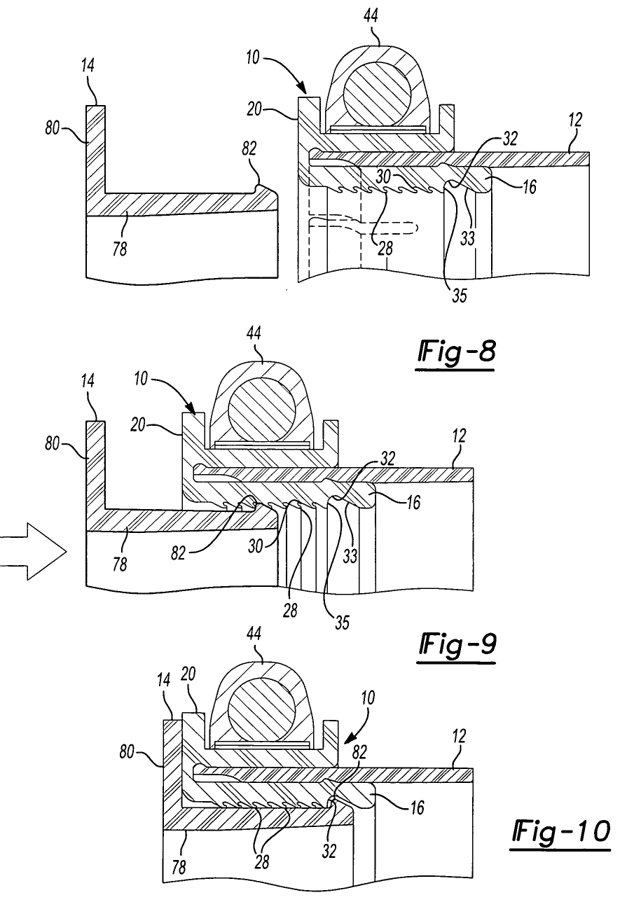

FIGS. 8-10 depict the tubular portion 78 of the throttle body 14 being received within the inner portion 16 of the cuff seal 10. Although FIGS. 8-10 depict the throttle body 14 engaging the cuff seal 10 after the air duct 12 is already in the fully engaged position, it should be appreciated that the throttle body 14 and the cuff seal 10 could be engaged first, before the air duct 12 is received within the annular groove 22. However, it is normally the case that first the air duct 12 is assembled into the cuff seal 10 and then the throttle body 14 is assembled into the cuff seal 10 because for shipping purposes to a final vehicle assembly, the air duct 12 and cuff seal 10 are first assembled and then shipped to a vehicle assembly facility where the air duct 12 and cuff seal 10 are assembled onto a vehicle throttle body 14. Upon insertion of the air duct 12 into the cuff seal 10, the air duct 12 will remain in the cuff seal 10, and the cuff seal 10 on the air duct 12, even without tightening the clamp 44, which is an advantage of the protuberance 76.

As the tubular portion 78 of the throttle body 14 is pressed into the inner portion 16 of the cuff seal 10 (or the cuff seal 10 is pressed over the tubular portion 78), the teeth or ribs 28 are resiliently compressed, as a type of cantilever rib, thereby providing a biasing force against the tubular portion 78. The undercuts 30 and the angle at which the ribs 28 protrude from the inner portion 16 may allow the ribs 28 to resiliently deflect in response to the force of the retaining barb 82 and the balance (length) of the tubular portion 78 sliding over each of the ribs 28 from left to right (relative to the view shown in FIG. 10). As described above, the ribs 28 may be relatively stiff in the opposite direction, thereby hindering the tubular portion 78 from sliding relative to the cuff seal 10 in a tubular portion 78 removal action, or a right to left direction (relative to the view shown in FIG. 10).

As the tubular portion 78 slides into the fully engaged position (FIG. 10), the retaining barb 82 may spring into or snap into the annular recess 32. As described above, the teardrop shape of the annular recess 32 allows the retaining barb 82 to snap therein, while hindering or preventing the retaining barb 82 from disengaging and backing out of the cuff seal 10 unless sufficient force is applied to the throttle body. During the installation of the cuff seal 10 and air duct 12 onto the throttle body 14, the fingers 72 deflect outwardly, away from the cuff seal 10 centerline to assist in creating a tight seal between all parts that the clamp 44 holds together when tightened. The diameter of the throttle body is sized to create such a flexing of the fingers 72 when the throttle body 14 is inserted into the cuff seal 10. The biasing force of the resiliently compressed ribs 28 against the tubular portion 78 may be a supplemental force in addition to the engagement between the retaining barb 82 and the annular recess 32. The biasing force of the ribs 28 against the tubular portion 78 and the biased engagement between the retaining barb 82 and the annular recess 32 may cooperate to form a sealed relationship between the throttle body 14 and the cuff seal 10, thereby providing a sealed connection between the throttle body 14 and the air duct 12. It should be appreciated that a service technician, for example, may be able to apply a sufficiently large force to disengage the retaining barb 82 and the annular recess 32 to remove the cuff seal 10 from the throttle body 14, if necessary.

Once the cuff seal 10 is restrainingly engaging both the air duct 12 and the throttle body 14 (as shown in FIG. 10), the clamp 44 may be tightened around the cuff seal 10 (as described above) to further restrain the air duct 12 and the throttle body 14 within the cuff seal 10, and to increase the forces that provide a sealing relationship therebetween. As shown in FIG. 10, the body 80 of the throttle body 14 may be disposed against the end portion 20 of the cuff seal 10, thereby further supplementing the seal between the throttle body 14 and the cuff seal 10.

There are multiple advantages to the teachings of the present disclosure. First, as described above, the air duct 12 and the throttle body 14 may be received into the cuff seal 10 with relative ease, while disengagement therebetween is hindered. The clamp 44 may provide a supplement to the sealed, detent or snap-fit relationships between the throttle body 14 and the cuff seal 10 and the air duct 12 and the cuff seal 10.

A second advantage of the principles of the present disclosure is that the air duct 12 does not contact the throttle body 14. The inner portion 16 of the cuff seal 10 is disposed between the air duct 12 and the throttle body 14, providing independent, biasingly sealed relationships between the air duct 12 and the inner portion 16 and the throttle body 14 and the inner portion 16. Therefore, differing coefficients of thermal expansion between the material of the air duct 12 and the material of the throttle body 14 will not compromise the integrity of the connection or seal therebetween as these components are exposed to a range of temperatures. Additionally, because the cuff seal 10 is the contact piece between the throttle body 14 and the air duct 12, and the throttle body 14 does not contact the air duct 12, the juncture of the cuff seal 10 with the air duct 12 and throttle body 14 permits engine vibration to be dampened. That is, no noise is generated by repeated, vibration contact between the throttle body 14 and the air duct 12, because they do not contact each other, and the cuff seal 10 acts as a vibration dampener.

Another advantage of the present disclosure is the multiple points, or surface area, of contact between the air duct 12 and the cuff seal 10 and between the throttle body 14 and the cuff seal 10, thereby providing a more robustly sealed connection. Connections that may only include one point of contact between two tubular members may increase the likelihood of air leaks, noise from vibration, and poor connection integrity.

Therefore, as described above, a sealing and connection system may employ an annular body 10 having an outer radial portion 18, an inner radial portion 16, and an end portion 20 that define a U-shaped cross-section and an annular groove 22 open at a first end and closed at a second end; and a clamp 44 disposed or secured around the outer radial portion 18. The clamp 44 possesses features to permit constriction of the annular body 10. The inner radial portion 16 includes a plurality of ribs 28, the ribs 28 being resiliently flexible in a first direction (in the direction of insertion of a tubular portion 78) and stiff in a second direction (in the direction of removal of the tubular portion 78).

The ribs 28 and the inner radial portion 16 define an undercut 30 to hasten deflection in the first direction. A surface of the outer radial portion 18 immediately bounding the annular groove 22 defines an annular recess 64 to engage a first tubular member 12 for a detent relationship therebetween. A surface of the inner portion 16 immediately bounding the annular groove 22 defines an annular protuberance 34 to engage the first tubular member 12 for a detent relationship therebetween. The inner portion 16, may be cantilevered and flexible, and the annular groove 22 may be adapted to receive the first tubular member 12 for a sealed engagement. The sealing and connection system may further employ a second tubular member 14 with the ribs 28 of the inner portion 16 protruding toward a longitudinal axis X of the annular body 10. The second tubular member 14 may reside within the annular body 10 and against the ribs 28 of the inner portion 16, the inner portion 16 being sandwiched between the first tubular member 12 and the second tubular member 14 to sealingly couple the first tubular member 12 and the second tubular member 14. The sealing and connection system may further employ a retaining barb 82 on the second tubular member 14, and the retaining barb 82 may reside within the inner portion annular recess 32. The second tubular member 14 may deflect the ribs 28 upon insertion to form a seal therebetween. The first tubular member 12 and the second tubular member 14 do not contact each other, and are separated by the inner portion 16.

In another example, a sealing and connection system may employ a first tubular member 12 having an inner diameter, an outer diameter, and defining a plurality of slots 70 disposed through the inner diameter and the outer diameter, and forming a plurality of flexible fingers 72. The flexible fingers are 72 located at an end of the first tubular member 12. A second tubular member 14 possesses an inner diameter and an outer diameter, the outer diameter having a rim, such as between body portion 80 and retaining barb 82. An annular cuff 10 may have an outer portion 18 and an inner portion 16 that define an annular groove 22 with a U-shaped cross-section. The annular cuff 10 may be adapted to sealingly secure, interconnect, or hold the first tubular member 12 and the second tubular member 14. The flexible fingers 72 of the first tubular member 12 may bias radially outwardly (away from axis X) and contact the outer portion 18, and the inner portion 16 bounding the annular groove 22. An outer diameter of the second tubular member 14 may be pressed into engagement with the inner portion 16 of the annular cuff 10. The inner portion 16 may be disposed between, and contacting, the first tubular member 12 and the second tubular member 14.

The sealing and connection system may further employ a plurality of ribs 28 on the inner portion 16 of the annular cuff 10 to provide radial force against the second tubular member 14 and prevent disengagement between the inner portion 16 and the second tubular member 14. The sealing and connection system may further employ a plurality of lips 76 on the plurality of fingers 72 that bias into a recess groove 64 within the annular groove 22.

The inner portion 16 may flex inward (toward the axis X) in response to insertion of the first tubular member 12. The inner portion 16 may bias the first tubular member 12 against the outer portion 18. The rim of the second tubular member 14 may be adapted with a retaining barb 82 to engage a groove 32 disposed in the inner portion 16. The annular cuff 10 may include an end portion 20 disposed against a flange of the second tubular member 14. The end portion 20 and the flange may abut to form a sealed relationship therebetween.

A clamp 44 is located around the outer portion 18, and when tightened it constricts the first tubular member 12, the second tubular member 14 and the inner portion 16 and outer portion 18 of the annular cuff 10. The sealing and connection system may further employ an annular protuberance 34 on the inner portion 16 and the plurality of flexible fingers 72 may include an undercut 74 to facilitate deflection of the fingers 72 upon finger contact with the protuberance 34.

In yet another example, a sealing and connection system may employ a first air duct 12 that defines a plurality of slots 70 disposed at a duct end, near a lip 76, thereby forming a plurality of flexible fingers 72. A tip of the fingers 72 may have a lip 76 on and with an outside diameter that is slightly larger than the balance of the first air duct. A second air duct 14 may have a tubular portion 78 and a flange portion, the tubular portion 78 further defining a channeled rim (body portion 80 and retaining barb 82). An annular cuff 10 may secure the first air duct 12 and the second air duct 14. The annular cuff 10 may have a U-shaped cross-section for receipt of the first air duct 12, an inner portion 16, and an outer portion 18. The inner portion 16 and the outer portion 18 define an annular groove 22 disposed therebetween. The inner portion 16 may have a plurality of ribs 28 and a first recess groove 32 next to the plurality of ribs 28.

A clamp 44 may be disposed around the outer portion 18 to secure the annular cuff 10 around the first air duct 12 and the second air duct 14. The flexible fingers 72 may be received into the annular groove 22 while the lip 76 on the fingers 72 biases into a second recess groove 64 disposed in a closed end of the annular groove 22. The tubular portion of the second air duct 14 is received against the inner portion 16, the plurality of ribs 28 deflecting during insertion of the tubular portion 78 and resisting disengagement between the tubular portion 78 and the inner portion 16, the plurality of ribs 28 being resiliently flexible in a first (insertion) direction, and less resilient in a second (withdrawal direction). Such a feature secures the tubular portion 78 of the second air duct 14 in place against the inner portion 16. Because each of the fingers 72 includes a finger tip undercut 74 to facilitate deflection of the fingers 72, the inner portion 16 resiliently flexes inward (toward axis X) in response to insertion of the first air duct 12 into the annular groove 22. An end portion 20 of the annular cuff 10 is disposed against the flange portion of the second air duct 14 to create a seal therebetween.

The description of the present disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A sealing and connection system comprising:
an annular body having an outer radial portion, an inner radial portion, and an end portion that define a U-shaped cross-section and an annular groove open at a first end and closed at a second end; and
a clamp disposed around the outer radial portion, the clamp being adapted to constrict the annular body.

2. The sealing and connection system according to claim 1, wherein the inner radial portion includes a plurality of ribs, the ribs being resiliently flexible in a first direction and stiff in a second direction.

3. The sealing and connection system according to claim 2, wherein the ribs and the inner radial portion define an undercut to hasten deflection in the first direction.

4. The sealing and connection system according to claim 1, wherein a surface of the outer radial portion immediately bounding the annular groove defines an annular recess to engage a first tubular member for a detent relationship therebetween.

5. The sealing and connection system according to claim 4, wherein a surface of the inner portion immediately bounding the annular groove defines an annular protuberance to engage the first tubular member for a detent relationship therebetween.

6. The sealing and connection system according to claim 5, wherein the inner portion is cantilevered and flexible, and the annular groove is adapted to receive the first tubular member for sealed engagement.

7. The sealing and connection system according to claim 6, further comprising:
a second tubular member, wherein the ribs of the inner portion protrude toward a longitudinal axis of the annular body and the second tubular member resides within the annular body and against the ribs of the inner portion, the inner portion being sandwiched between the first tubular member and the second tubular member to sealingly couple the first tubular member and the second tubular member.

8. The sealing and connection system according to claim 7, further comprising:
a retaining barb on the second tubular member; and
an inner portion annular recess, the retaining barb residing within the inner portion annular recess, the second tubular member deflecting the ribs to form a seal.

9. The sealing and connection system according to claim 8, wherein the first tubular member and the second tubular member do not contact each other.

10. A sealing and connection system comprising:
a first tubular member having an inner diameter, an outer diameter, and defining a plurality of slots disposed through the inner diameter and the outer diameter, and forming a plurality of flexible fingers, the flexible fingers located through an end of the first tubular member;
a second tubular member including an inner diameter and an outer diameter, the outer diameter having a rim; and
an annular cuff having an outer portion and an inner portion, the inner and outer portions defining an annular groove with a U-shaped cross-section, the annular cuff adapted to sealingly interconnect the first tubular member and the second tubular member,
wherein the flexible fingers of the first tubular member bias radially outwardly and contact the outer portion and the inner portion bounding the annular groove, and an outer diameter of the second tubular member is pressed into engagement with the inner portion of the annular cuff, the inner portion disposed between, and contacting, the first tubular member and the second tubular member.

11. The sealing and connection system according to claim 10, further comprising:
a plurality of ribs on the inner portion of the annular cuff to provide radial force against the second tubular member and prevent disengagement between the inner portion and the second tubular member.

12. The sealing and connection system according to claim 10, further comprising:
a plurality of lips on the plurality of fingers; and
a recess groove within the annular groove, wherein the lips are biased into the recess groove.

13. The sealing and connection system according to claim 10, wherein the inner portion flexes inward in response to insertion of the first tubular member, the inner portion biasing the first tubular member against the outer portion.

14. The sealing and connection system according to claim 10, wherein the rim of the second tubular member is adapted to engage a groove disposed in the inner portion.

15. The sealing and connection system according to claim 10, wherein the annular cuff includes an end portion disposed against a flange of the second tubular member, the end portion and the flange abut to form a sealed relationship therebetween.

16. The sealing and connection system according to claim 10, wherein a clamp disposed around the outer portion constricts the first tubular member, the second tubular member and the annular cuff.

17. The sealing and connection system according to claim 10, further comprising:
an annular protuberance on the inner portion, wherein the plurality of flexible fingers include an undercut to facilitate deflection of the fingers upon finger contact with the protuberance.

18. A sealing and connection system comprising:
a first air duct defining a plurality of slots disposed at a duct end to form a plurality of flexible fingers, a tip of the fingers having a lip on an outside diameter that is slightly larger than the balance of the first air duct;
a second air duct having a tubular portion and a flange portion, the tubular portion further defining a channeled rim;
an annular cuff securing the first air duct and the second air duct, the annular cuff having a U-shaped cross-section for receipt of the first air duct, an inner portion, an outer portion, wherein the inner portion and the outer portion define an annular groove disposed therebetween, the inner portion having a plurality of ribs and a first recess groove next to the plurality of ribs; and
a clamp disposed around the outer portion, the clamp securing the annular cuff around the first air duct and the second air duct,
wherein the flexible fingers are received into the annular groove and the lip on the fingers biases into a second recess groove disposed in a closed end of the annular groove,
wherein the tubular portion of the second air duct is received against the inner portion, the plurality of ribs deflecting during insertion of the tubular portion and resisting disengagement between the tubular portion and the inner portion, the plurality of ribs being resiliently flexible in a first, insertion direction and less resilient in a second, withdrawal direction.

19. The sealing and connection system according to claim 18, wherein each of the ribs includes an undercut to facilitate deflection of the ribs in the first direction.

20. The sealing and connection system according to claim 18, wherein an end portion of the annular cuff is disposed against the flange portion.

21. The sealing and connection system according to claim 18, wherein each of the fingers includes a finger tip undercut to facilitate deflection of the fingers, the inner portion resiliently flexes inward in response to insertion of the first air duct into the annular groove.
